(19) United States
(12) Patent Application Publication
(10) Pub. No.: US 2026/0217591 A1
(43) Pub. Date: Jul. 30, 2026

(54) REDUCTION OF LOSS AND IMPROVED LONG-TERM RELIABILITY OF HOLLOW CORE FIBERS

(71) Applicants: Microsoft Technology Licensing, LLC, Redmond, WA (US); University of Southampton, Southampton (GB)

(72) Inventors: Marco PETROVICH, Southampton (GB); Dmytro SUSLOV, Southampton (GB); Shahab BAKHTIARI GORAJOOBI, Southampton (GB); Natalie WHEELER, Southampton (GB)

(21) Appl. No.: 19/453,891

(22) Filed: Jan. 20, 2026

Related U.S. Application Data
(60) Provisional application No. 63/750,969, filed on Jan. 29, 2025.

(51) Int. Cl. C03B 37/10; C03B 37/025; G02B 6/032

(52) U.S. Cl. CPC C03B 37/10; C03B 37/0256; G02B 6/032; C03B 2203/16

(57) ABSTRACT

A method of fabricating a hollow core optical fiber. The method comprising: providing a preform comprising a transverse cross-sectional structure comprising a hollow core surrounded by a plurality of capillaries defining a plurality of voids encased by a tubular cladding. The hollow core and the plurality of voids extend longitudinally along a length of the preform. The method further comprising purging the preform by flowing gas comprising a noble gas through the hollow core and the plurality of voids, and subsequent to purging the preform, drawing a hollow core optical fiber by passing the purges preform through a draw furnace heated to a temperature suitable for softening a material of the preform.

### CROSS-REFERENCE TO RELATED APPLICATIONS

This application claims priority to, and the benefit of, U.S. Provisional Application No. 63/750,969, filed Jan. 29, 2025, and entitled “REDUCTION OF LOSS AND IMPROVED LONG-TERM RELIABILITY OF HOLLOW CORE FIBERS,” the entire contents of which are incorporated by reference herein in their entirety.

### BACKGROUND

Hollow Core Fibers are a new class of optical fibers. In contrast to traditional solid core fibers, light is guided in a hollow central core rather than solid glass. Hollow core fibers provide numerous benefits compared to solid core fibers such as reduced optical propagation loss, increased signal propagation speed, wider optical transmission bandwidth and reduced parasitic nonlinear optical effects. Hollow core fibers can also withstand higher damage thresholds compared to solid core fibers.

Optical fibers are utilized for high-capacity data transmission over long distances and are becoming increasingly important as consumers and businesses become reliant on network services and cloud storage and computing resources. The key advantages provided by hollow core fibers compared to solid core fibers, as highlighted above, make them a better candidate for various application in the field of data transmission. Challenges associated with mass producing reliable hollow core fibers will therefore need to be overcome if they are to be deployed in optical cloud networks.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

According to a first aspect of the certain embodiments described herein, there is provided a method of fabricating a hollow core optical fiber. The method comprises: providing a preform comprising a transverse cross-sectional structure comprising a hollow core surrounded by a plurality of capillaries defining a plurality voids encased by a tubular cladding, wherein the hollow core and the plurality of voids extend longitudinally along a length of the preform, purging the preform by flowing gas comprising a noble gas through the hollow core and the plurality of voids, and subsequent to purging the preform, drawing a hollow core optical fiber by passing the purged preform through a draw furnace heated to a temperature suitable for softening a material of the preform.

According to a second aspect of the certain embodiments described herein, there is provided a system for fabricating a hollow core optical fiber. The system comprising: a preform mount for holding a preform, a noble gas supply system connected to an arrangement of gas conduits, wherein the arrangement of gas conduits includes channels with openings positioned where the openings of a hollow core and a plurality capillaries defining a plurality of voids of a preform would be positioned with a preform mounted in the preform mount, and wherein the noble gas supply system is configured to flow gas comprising a noble gas through the preform mounted in the preform mount, and a draw furnace which is configured to be heated to a temperature suitable for softening a material of the preform material.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic transverse cross-sectional view of a hollow core photonic band gap fiber;

FIG. 2 is a schematic transverse cross-sectional view of an antiresonant hollow core fiber;

FIG. 3 is a schematic transverse cross-sectional view of a nested nodeless antiresonant hollow core fiber;

FIG. 4 is a schematic transverse cross-sectional view of a double nested nodeless antiresonant hollow core fiber;

FIG. 5 is a schematic transverse cross-sectional view of a triple nested nodeless antiresonant hollow core fiber;

FIG. 6 is a flow diagram of a method for fabricating hollow core optical fiber;

FIG. 7A is a schematic transverse cross-sectional view of a double nested nodeless antiresonant hollow core fiber preform encased within an outer jacket;

FIG. 7B is a schematic of a side on view of a double nested nodeless antiresonant hollow core fiber preform encased within an outer jacket;

FIG. 8 is a schematic of a side on view of a double nested nodeless antiresonant hollow core fiber preform with an arrangement of gas conduits;

FIG. 9 is a schematic of a side on view of a double nested nodeless antiresonant hollow core fiber preform with an arrangement of gas conduits where the tubular cladding forms a sealed end;

FIG. 10 is a schematic of a side on view of a double nested nodeless antiresonant hollow core fiber preform encased within an outer jacket with an arrangement of gas conduits;

FIG. 11 is a schematic of a side on view of a double nested nodeless antiresonant hollow core fiber preform where the tubular cladding is joined to individually seal the channels of the preform;

FIG. 12 is a schematic of a side on view of a double nested nodeless antiresonant hollow core fiber preform where the outer cladding is joined to individually seal the channels of the preform; and

FIG. 13 is a schematic of a system for fabricating hollow core optical fiber.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

In hollow core optical fibers, light is guided through a longitudinal hollow central core, rather than in solid glass as is the case for solid core fibers. Typically, a hollow core fiber includes a central hole surrounded by a plurality of peripheral channels extending longitudinally along the fiber length. As will be explained later, the plurality of peripheral channels may be located in various geometry arrangements and have very high longitudinal consistency. Compared to solid core fibers, hollow core fibers provide potential benefits such as reduced loss from both glass absorption and scattering, increased propagation speed and reduced optical nonlinearities making hollow core optical fiber very attractive for use in applications such as telecommunications. However, manufacturing hollow core optical fiber in lengths that are practical for telecommunications (tens to hundreds of kilometers) is challenging owing to the complexities in controlling the microstructure within the hollow core fiber. This is particularly important if hollow core fibers are to be used to connect data centers located in geographically remote areas. Two classes of hollow core fibers include the hollow core photonic band gap fiber (HC-PBGF, which is sometimes referred to as hollow core photonic crystal fiber, HC-PCF) and antiresonant hollow core fiber (AR-HCR or ARF). The methods and systems described herein are applicable to both classes of hollow core fiber.

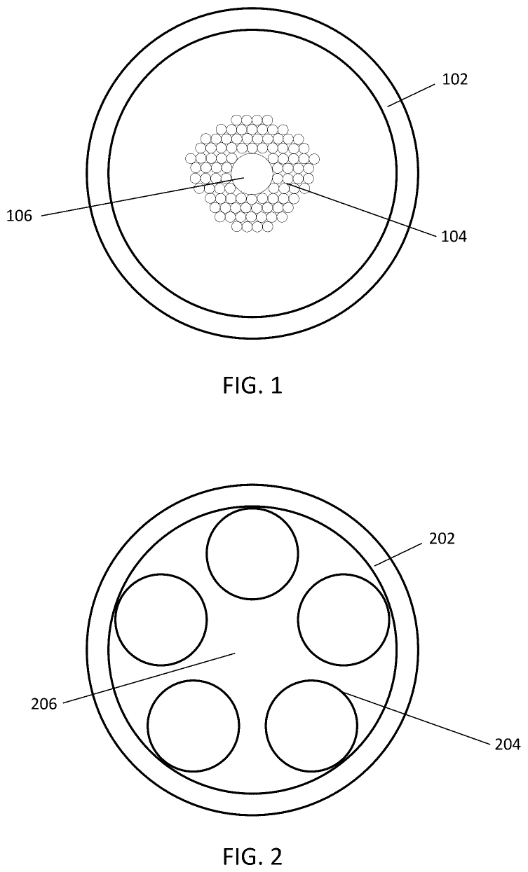

FIG. 1 shows a schematic transverse cross-sectional view of an example HC-PBGF. In this fiber type, a structured, inner, cladding 102 comprises a substantially regular closely packed array of many small glass capillaries 104 (defining the longitudinal voids) from which a central group is excluded to define substantially circular hollow core 106. The periodicity of the cladding structure provides a periodically structured refractive index and hence a photonic bandgap effect that confines the propagating optical wave towards the core. This is the fundamental optical mode or fundamental mode (FM). One or more higher-order optical modes or higher-order modes (HOMs) may be supported in the core and/or the cladding.

FIG. 2 shows a schematic transverse cross-sectional view of an example antiresonant hollow core fiber (ARF). In contrast to the HC-PBGF illustrated in FIG. 1, the antiresonant hollow core fiber has a much simpler configuration comprising a lower number of larger capillaries or tubes defining the longitudinal voids extending along the fiber length. The antiresonant hollow core optical fiber has an outer tubular cladding 202, a structured, inner, cladding comprising a plurality of tubular capillaries 204 extending longitudinally along the length of the fiber which are attached to the inner surface of the tubular cladding. The plurality of tubular capillaries is arranged to form a ring around the inner surface of the tubular cladding and define a hollow core 206. The tubular capillaries define the plurality of voids surrounding the hollow core, and in some cases are spaced evenly around the inner surface of the outer cladding.

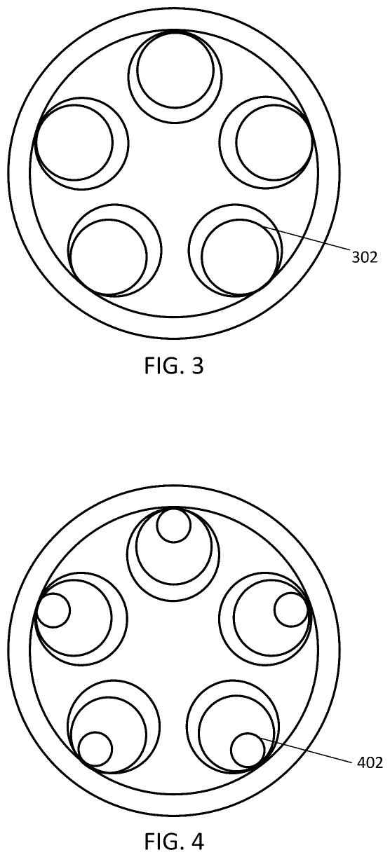

FIG. 3 shows a schematic transverse cross-sectional view of a second example of an antiresonant hollow core fiber. The specific example shown in FIG. 3 is a nested antiresonant nodeless fiber (NANF). It differs from the antiresonant hollow fiber of FIG. 2 in that it includes additional capillaries 302 nested within the tubular capillaries. The inclusion of nested capillaries has been shown to reduce loss within antiresonant hollow core fibers and also to improve the model purity. It achieves this by making the fiber single mode, suppressing the higher order modes which is a quality that is desirable for data transmission.

FIG. 4 shows a schematic transverse cross-sectional view of a third example of an antiresonant hollow core fiber. The specific example shown in FIG. 4 is a double nested antiresonant nodeless fiber (DNANF). It differs from the NANF of FIG. 3 in that it includes a first additional capillary 402 nested within the larger nested capillaries. The addition of further nested capillaries provides an additional reduction of optical losses within antiresonant hollow core fibers.

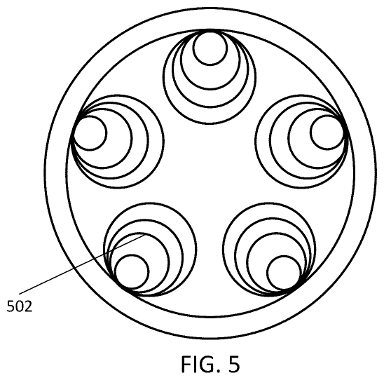

FIG. 5 shows a further extension of the DNANF which is the triple nested antiresonant nodeless fiber (TNANF). The TNANF differs from the DNANF whereby a second additional capillary 502 included into the sets of nested capillaries.

Although it is not illustrated in the Figures, other types of hollow core fibers extend to those including any arbitrary number of nested elements and different resonator shapes that are arranged to provide a central hole surrounded by a plurality of peripheral voids extending longitudinally along the fiber length.

All of the examples shown in FIGS. 2 to 5 comprise five primary cladding capillaries (outer tubular capillaries 204) and hence have five-fold rotational symmetry. Furthermore, all the cladding capillaries are shown to be circular in cross-section. In other examples, there may be a different number of primary cladding capillaries surrounding the core (e.g. four, six, seven, eight, nine or ten) and/or the cladding capillaries may not be of circular cross-section. Additionally, whilst in the examples of FIGS. 2 to 5, all the primary cladding capillaries 204 are of the same size and shape, in other examples, the primary cladding capillaries within the tubular cladding 202 may not all be the same size and/or shape.

Light attenuation mechanisms typical of solid core fibers are generally not applicable to hollow core fibers and are replaced by new mechanisms. As such, optical loss in hollow core fibers is primarily determined by the design, geometry and longitudinal uniformity of the microstructure (e.g., in DNANF, by the size and thickness of resonators, or nested capillaries, defining the hollow core). These properties define the transmission window (the range of wavelengths which are transmitted) and its depth (how low the transmission loss is at those wavelengths). However, an additional loss mechanism is possible as a result of chemical species present in the hollow core. The most common case is from gas molecules which are optically active at wavelengths within the transmission window (e.g., near-IR (NIR) or short-wavelength infrared (SWIR)). In some instances, the absorption lines of gas molecules overlap with telecommunication transmission wavebands and can therefore impair data transmission. For example, CO₂ has absorption lines in both the C-band and in the L-telecommunication bands, whereas water vapor has absorption lines in the S and O-bands. Other gases such as hydrogen chloride, ammonia and carbon monoxide have also been observed in hollow core fibers and can contribute to transmission loss of the fiber at other wavelengths. Traces of other substances have been detected in hollow core fibers which can also contribute to optical losses as well as contributing to the general degradation of the hollow core fiber.

A problem that is also encountered that is specific to hollow core fibers is that gases (e.g., atmospheric gases such as oxygen (O₂) and nitrogen (N₂)) which do not have optical absorption lines in the telecommunication transmission wavebands and are inert at room temperature, can give rise to reactive or light absorbing species when mixed together and with other species present in hollow core fiber (e.g., water vapor, hydrochloric acid) and brought to the high temperatures used in a drawing furnace. The unstable compounds formed in the draw furnace can, in some instances, condense droplets or form crystals in the voids in the core of the hollow core optical fiber. This type of contamination can mean hollow core fiber kept in storage is rendered unusable within a matter of weeks. In more serious circumstances, hollow core optical fiber deployed underground would need to be excavated if such an event were to occur. This highlights the importance of removing contaminants from the fibers.

The impact of chemical species present in the core over these lengths is typically less severe compared to the losses caused by the design, geometry, and longitudinal uniformity of the microstructure within the hollow core fiber. However, as research into hollow core fibers has progressed, the losses caused by the microstructure within the hollow core has been significantly reduced. This means the previously insignificant losses caused by the chemical species in the hollow core now contribute to a larger share of optical loss in hollow core fibers. As a result, losses caused by chemical species in the core is the next challenge to be addressed since it has not been a major problem until recently. For example, a conventional method of mitigating these issues is by judiciously designing the transmission systems to account for the impact on specific bands in the NIR wavelength range. However, as hollow core fiber of lengths over 100 km become achievable, the impact of losses from contamination in the core will become more important when optimizing transmission performance.

The methods and systems described herein address the issues discussed above and are applicable to any hollow core optical fiber such as those illustrated in FIGS. 1 to 5. In particular, the methods and systems remove, or at least vastly reduce, species present in the hollow core optical fiber which negatively affect the optical performance and long-term reliability of the fibers.

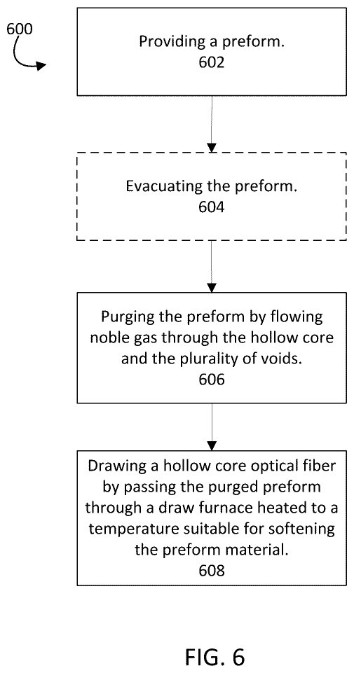

FIG. 6 shows a flow chart of steps in a method 600 for fabricating hollow core optical fiber. In the first step 602, a preform is provided comprising a transverse cross-sectional structure comprising a hollow core surrounded by a plurality of voids encased by a tubular cladding. The hollow core and the plurality of voids extend longitudinally along the length of the preform. The transverse cross-sectional structure of the hollow core fiber comprises a hollow core surrounded by a plurality of peripheral voids, where the hollow core and the peripheral voids are encased by a tubular cladding. The hollow core and the plurality of voids extend longitudinally along the length of the preform. The transverse cross-section structure may be any of the example hollow core fiber structures described previously including, but not limited to, a HC-PBGF, ARF, NANF, DNANF or a TNANF. As will be explained in more detail, the preform may be a single piece (i.e., without a jacket) or may include an outer jacket surrounding the tubular cladding of the preform.

In the context of this method 600, “a preform” is understood to encompass preforms with a larger width compared to the hollow core optical fiber that is drawn from the method. For example, the preform may be a large initial preform which is yet to be drawn into a thinner preform. This may have a diameter of at least 20 mm or at least 50 mm. In other examples, this may have a diameter of at least 100 mm or at least 250 mm. In other examples, the preform may have already been drawn into a cane which has an intermediate thickness between the large initial preform and the thickness of the hollow core optical fiber. The outer diameter of the cane may be between 0.5 to 20 mm. In other examples, this may have a diameter of at least 100 mm. Using a cane with a smaller diameter may result in greater purging efficiency particularly when evacuating before backfilling the preform with noble gas, as will be discussed later.

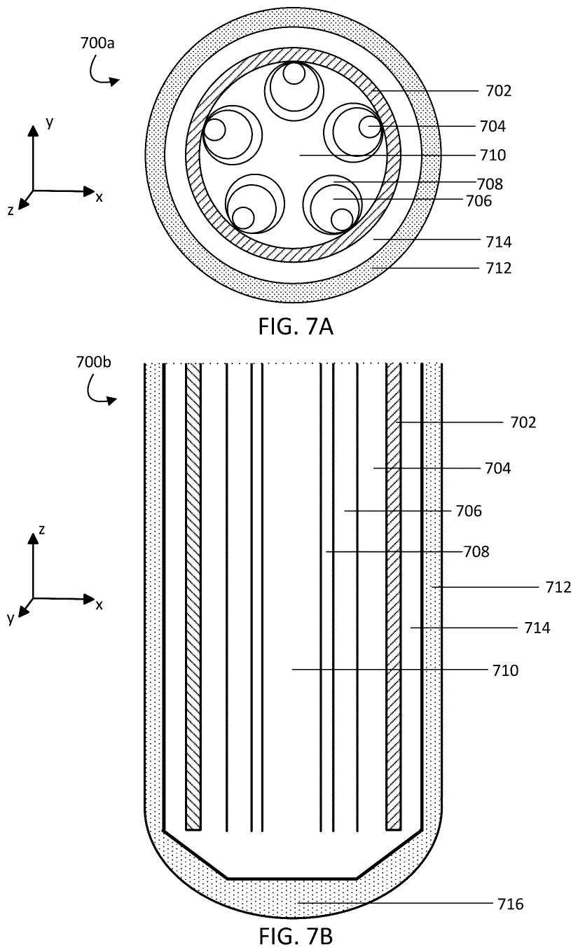

The provided preform may further comprise an outer jacket defining a cavity between the outer jacket and the tubular cladding. This is illustrated in FIGS. 7A and 7B which show schematics of a cross section of the preform 700a and the view from the side of the preform 700b respectively. The horizontal spacing of the structure of the preform shown in FIG. 7B is aligned with the spacing of the internal structure of FIG. 7A. In this example the preform has the internal structure of a DNANF, however it should be appreciated that any of the hollow core optical fiber structures (e.g., those illustrated in FIGS. 1 to 5) can also comprise an outer jacket defining a cavity between the outer jacket and the outer surface of the tubular cladding. The DNANF hollow core fiber comprises a tubular cladding 702, encasing a plurality of nested capillaries including inner 704, middle 706 and outer 708 capillaries. As discussed previously, the inner capillary 704 is nested within the middle capillary 706, and the middle capillary 706 is nested within the outer capillary 708. The inner, middle and outer capillaries, for a single set of nested capillaries, define three voids or channels. Thus, for a single set of nested capillaries, the inner capillary 704 defines a first void or channel, the middle capillary 706 defines a second void or channel between the inner surface of the middle capillary 706 and the outer surface of the inner capillary 704, and the outer capillary defines a third void or channel between the inner surface of the outer capillary 708 and the outer surface of the middle capillary 706. The multiple sets of nested capillaries surrounding the hollow core 710 therefore provide multiple voids surrounding the hollow core 710. The schematic of the side view of the preform 700b shown in FIG. 7B includes two sets of the nested capillaries so the different voids defined by the inner 704, middle 706 and outer 708 capillaries as described above are clear to see. The ring of outer capillaries arranged around the inner surface of the tubular cladding define a hollow core 710. An outer jacket 712 encases and surrounds the tubular cladding of the DNANF thus defining a cavity 714 between the outer surface of the tubular cladding 702 and the inner surface of the outer jacket 712. The ends of the nested capillaries 704, 706, 708 and the hollow core 710 are open in the perform whereas the outer jacket 712 has a closed end 716 as shown in FIG. 7B. The top end (opposite the closed end of the outer jacket 712) of the cavity 714, the channels defined by the nested capillaries and hollow core are open and can thus serve as an inlet or outlet for a gas flow as will be discussed further later in this disclosure. The cavity 714 is eliminated during the draw of the hollow core optical fiber such that the outer jacket 712 contacts and encases the tubular cladding 702.

In some examples, the method proceeds to step 604 where the preform is evacuated with the application of a vacuum.

The method proceeds to step 606 which involves purging the preform by flowing a noble gas through the hollow core and the plurality of voids. As will be discussed in more detail later, the purging of the preform can be performed by diluting gases already present in the preform with the noble gas without evacuating the preform. If the step 604 is performed prior to step 606, the evacuation and subsequent purging with noble gas can be repeated several times such that any residual gas present as a result of imperfect evacuation is reduced. The noble gas used may be argon since it is relatively inexpensive compared to other inert gases. Other noble gases which may be used includes helium, neon, xenon and krypton or any mixtures thereof.

Prior to performing the purging, the preform may be mounted on the drawing tower being used to draw hollow core optical fiber from the preform. Performing the purging without having to transport the preform to the mounting tower reduces the risk of contamination before drawing. As discussed previously, the presence of oxygen and/or nitrogen in the preform can result in reactive species being created in the hollow core optical fiber due to the high temperatures used in the draw furnace. Thus, mounting the preform prior to purging the preform reduces the risk of excessive oxygen and nitrogen being present in the preform when the drawing of the fiber is started.

In another example, if a draw tower lacks the means to mount and purge the perform before drawing, lengths of the preform may be purged on a separate apparatus and then immediately being drawn into the hollow core optical fiber. Alternatively, the purged preform may be stored under controlled atmospheric conditions until it is time for the preform to be drawn into fiber to minimize contamination (e.g. they may be stored within a sealed tube containing a noble gas).

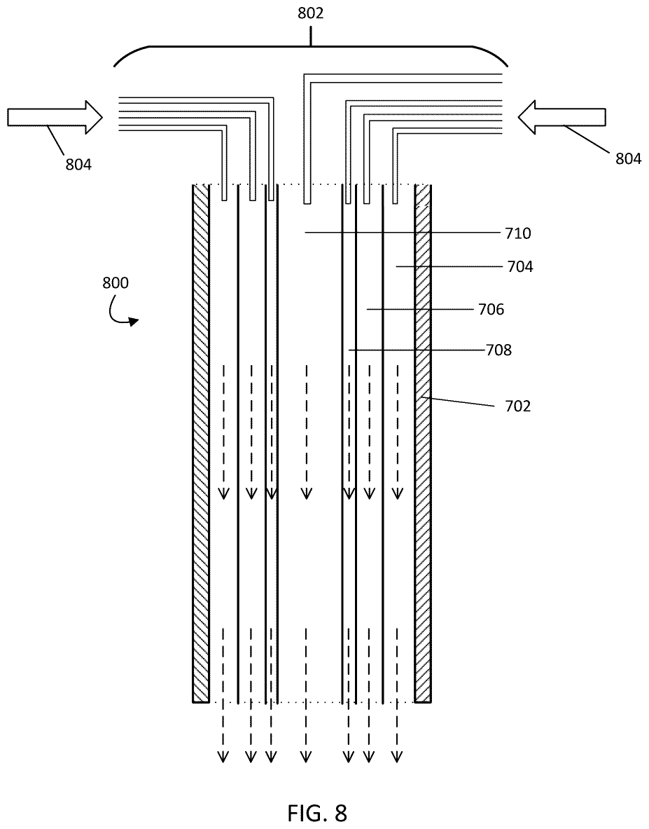

An example of how the noble gas may be flowed through the preform is shown in FIG. 8. It shows a schematic of an arrangement of gas conduits 802 configured to provide noble gas 804 (e.g., argon) through the hollow core 710, and the surrounding voids defined by the inner 704, middle 706 and outer 708 capillaries. FIG. 8 shows a preform 800 with an open end (i.e., without an outer jacket or sealed end) such that the noble gas exits at the opposite end of the preform from where it is provided. The flow of noble gas is shown by the dashed lines. A plurality of void inlets is used in addition to an inlet for the hollow core. Of course, should the structure of the preform be changed (e.g., HCPBF, antiresonant fiber, NANF or TNANF), then the arrangement of gas conduits 802 will be adapted to the number of voids present in the preform.

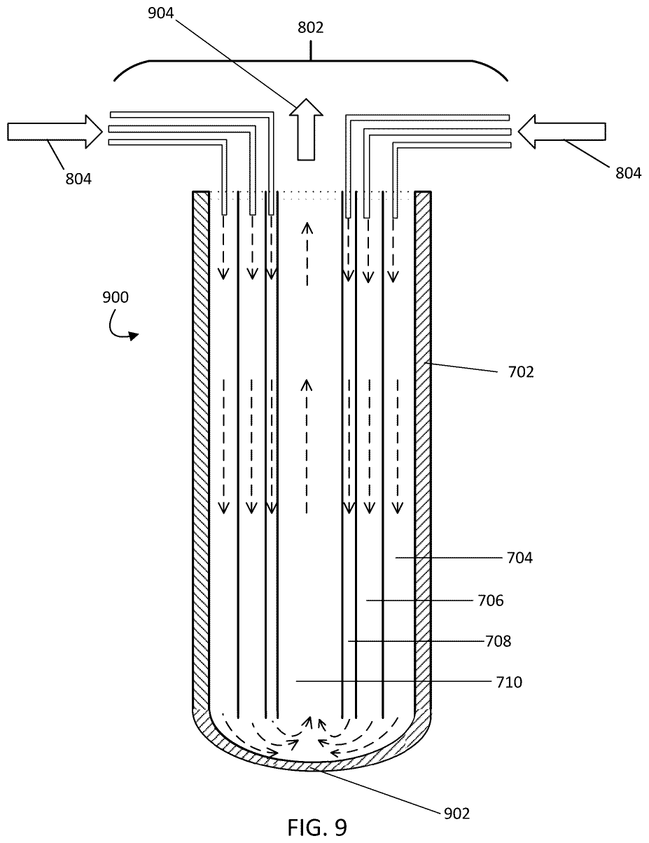

Another example of how the noble gas may be flowed through the preform is shown in FIG. 9. It shows the same arrangement of gas conduits 802 provided at the inlets defined by openings of the plurality of voids and the hollow core of the preform as illustrated in the example of FIG. 8. In contrast, the preform 900 comprises a sealed or closed end 902 where the tubular cladding 702 is joined to form the seal. In another example, although it is not illustrated in FIG. 9, the preform 900 may be encased within an outer jacket where the inner surface of the outer jacket contacts the outer surface of the tubular cladding 702.

FIG. 9 also shows an example flow direction of the noble gas through the preform which may be implemented in the methods described herein. Where the preform 900 comprises a sealed end 902 formed by the joining of the tubular cladding 702, noble gas may be flowed through the plurality of voids, which in this example are defined by the sets of inner 704, middle 706 and outer 708 capillaries. The flow of the noble gas may then exit 904 the preform 900 from the opening of the hollow core 710. This approach would mean providing a gas conduit into the hollow core would not be necessary, thus reducing the complexity of purging the preform. Although it is not depicted here, where the preform 900 has a sealed end 902 as shown in FIG. 9, the noble gas may also be flowed through the hollow core 702 and exit from at the openings of the plurality of voids.

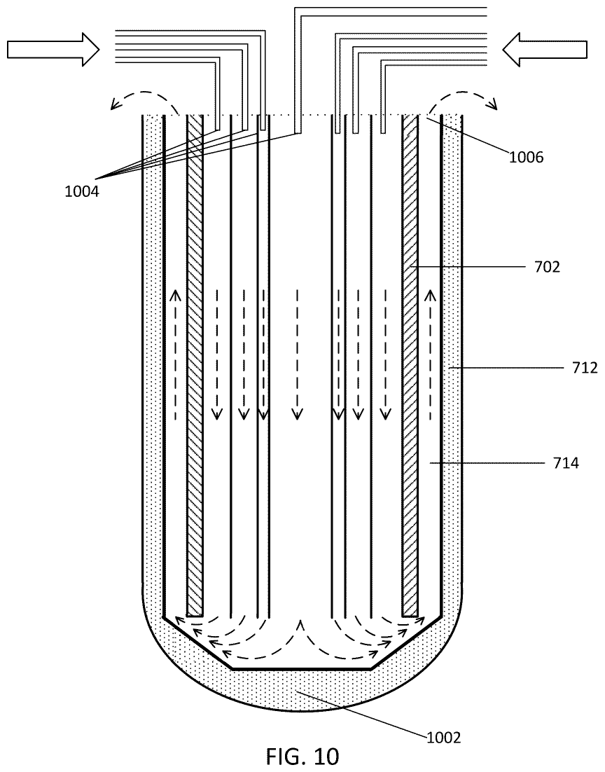

Another example of how the noble gas may be flowed through the preform is shown in FIG. 10. It shows the same arrangement of gas conduits to provide the noble gas as shown in FIG. 8, however, the preform is encased within an outer jacket 712 defining a cavity 714 between the inner surface of the outer jacket and the outer surface of the tubular cladding 702. Similarly with the discussion of FIG. 7, the ends of the nested capillaries and the hollow core are open in the perform whereas the outer jacket has a closed end 1002. In the example shown in FIG. 10, the voids defined by the nested capillaries and the hollow core serve as the inlets 1004 for the supply of noble gas whereas the open end of the cavity serves as the outlet 1006. This is represented by the direction of the dashed arrows in FIG. 10. This flow configuration may result in a more effective purging of the hollow core and the plurality of voids since higher pressures at the start of the flow path will reduce the likelihood of contaminates being formed at the open end of the fiber which is where contamination is most common. However, any configuration of using the hollow core, the plurality of voids and the cavity as the inlets or outlets for the noble gas flow may be used.

To ensure all contaminants are removed before the drawing of the fiber, the purging may be performed at different temperatures. For example, the purging may be performed at ambient or room temperature for a first time period. Purging the preform at room temperature eliminates absorbing gas species already present in the preform (e.g., CO₂) or reactive gas species and vapors which may give rise to absorbing gas species and/or unstable gas species which affect the long-term stability of the fiber. The purging may then be performed at an elevated temperature for a second time period. The elevated temperature may be between 200 and 1000° C. to ensure that water is removed from the glass (and other) surfaces within the preform. In other examples, the elevated temperature is between 600 and 1200° C. In further examples, the temperature is between 1000° C. and 1500° C. However, the upper limit of the evaluated temperature should not exceed the temperature at which the material (e.g., glass) of the preform begins to soften. The purpose of the purging at multiple temperatures is to target different types of contaminants that may be present in the preform. For example, contaminants present adsorbed on surfaces inside the preform may need sufficient heat to be removed, whereas without a purging step at an elevated temperature the contaminants could react at the high temperatures used during the draw creating new species in the hollow core. In another example, purging at an elevated temperature relative to room temperature removes water vapor which may be present on the glass surface and/or inside the glass and/or other materials present in the preform as they dry. In addition, purging at room temperature reduces the chances of any contaminants reacting at the elevated temperatures of the second time period. Purging at the elevated temperature also causes further gas molecules to be evolved from the glass volume or glass surfaces within the preform and from the surface or volume of other materials typically used to assemble preforms, such as polymer seals, metal parts, etc. The length of first and second time periods is dependent on the volume of the preform that is being purged. However, for preforms with an outer diameter of 10 to 30 mm, the length of time for the first and second time periods which provides optimum results is between 3 to 20 minutes. For smaller preforms with an outer diameter of 0.5 to 10 mm, time periods of 1 to 10 minutes were found to be optimum. For larger preforms with a diameter greater than 30 mm, 5 to 30 minutes has provided optimum results.

The gases, or mixture of gases, used to purge the preform during the first time period (at room temperature) and the second time period (at an elevated temperature) may vary to provide additional benefits. In one example, during the first time period, a mixture of noble gas and a reactive gas (e.g. oxygen) may be used to purge the preform, and during the second time period 100 % noble gas may be used. Using a reactive gas in the gas mixture may encourage reactions to take place during the first time period so that the reactants remaining from the first time period are removed during the second time period at elevated temperature. This reduces the likelihood of contaminates or substances being present in the preform that could react with reactive gases during the draw of the hollow core optical fiber.

The purging of the preform can be performed in various ways. However, both of the purging methods discussed below may be performed at different temperatures for separate time periods as discussed above. A first purging method involves flowing a noble gas through the plurality of voids and hollow core in the preform to dilute the gas already present in the preform. This method is simple to implement as it only requires a single gas flow step. Purging the preform by diluting the gases already present in the preform may include, during the purging process, determining the concentration of the noble gas present in the hollow core and the plurality of voids. Determining the gas concentration can be achieved using any suitable gas sensor (e.g., oxygen sensors, nitrogen sensors, CO₂ sensors or mass spectrometry sensors that can detect multiple gases at once). A predetermined threshold may be set for the gas content of the preform during the purging process which acts as the indicator to cease flowing noble gas through the preform. In some examples, the threshold may be above 95%, however thresholds above 99% provide greater contamination reduction reliability.

A second method involves a two-stage approach whereby the hollow core and the plurality of voids are evacuated before the noble gas is flowed through the hollow core and plurality of voids. Evacuating the hollow core and the plurality of voids involves lowering the pressure inside the core and the voids. This can be achieved using a vacuum pump to remove gas from the voids and hollow core in the preform. The evacuation can be performed using the same gas conduits to supply the flow of noble gas. Using the two-stage approach has numerous benefits compared to diluting the gas in the preform using the first method. For example, the process requires less noble gas if the preform is evacuated first since diluting the gas in the preform requires large amounts of noble gas to “push out” any other gases in order to reach noble gas levels of over 99%. Although introducing a new step into the purging process increases the complexity, the cost of supplying the noble gas is reduced. In addition, the two-stage method can also be repeated multiple times (i.e., evacuating the preform, flowing gas through the preform, evacuating the preform again before flowing noble gas through the preform again). Repeating the two-stage process multiple times instead of using the continuous gas flow of the first method results in much lower concentrations of contaminants, or at least lower concentrations of contaminants (or higher concentrations of noble gas) that can be achieved on a shorter timescale.

Similarly with the first purging method, a predetermined threshold may be set for the gas content of the preform during the purging process which acts as the indicator to cease flowing noble gas through the preform.

Referring back to FIG. 7B, the two-stage approach may be implemented by evacuating the hollow core 710 and plurality of voids defined by the inner 704, middle 706, and outer 708 capillaries through the cavity 714 defined by the inner surface of the outer jacket 712 and the outer surface of the outer cladding 702. Following the evacuation, the noble gas may then be supplied as illustrated and described in reference to FIG. 10 (i.e., in through the inlets of the hollow core and the plurality of voids and out of the cavity). Alternatively, in the example illustrated in FIG. 9 where the preform 900 is sealed at the end of the preform 902 using the tubular cladding 702, the preform 900 may be evacuated through the hollow core 710 before being backfilled with noble gas through the inlets defined by the openings of the plurality of voids (e.g., the inner 704, middle 706, and outer capillaries 708). Although FIGS. 8 to 10 show specific examples of the noble gas flow that can be implemented, alternative gas flow schemes can also be implemented. For example, the preform may be evacuated through the plurality of peripheral voids and then backfilled with noble gas through the hollow core of the preform.

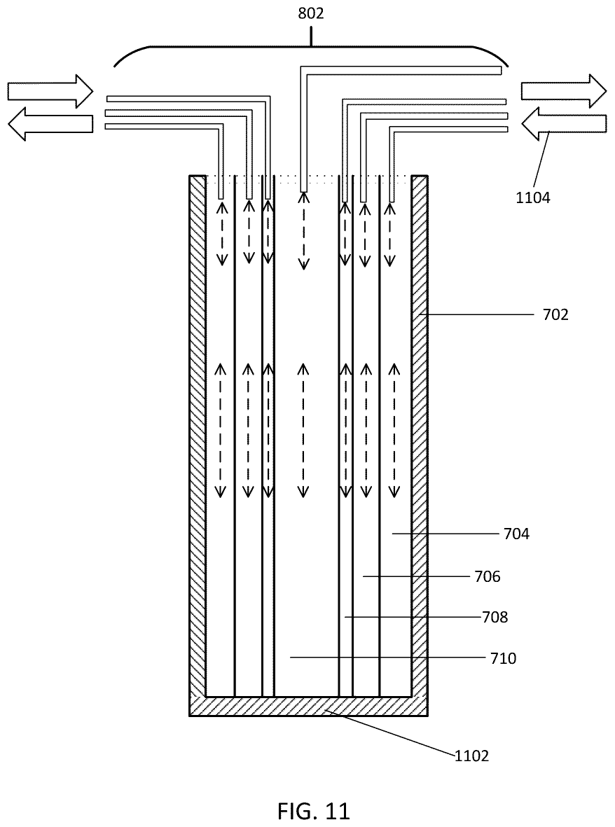

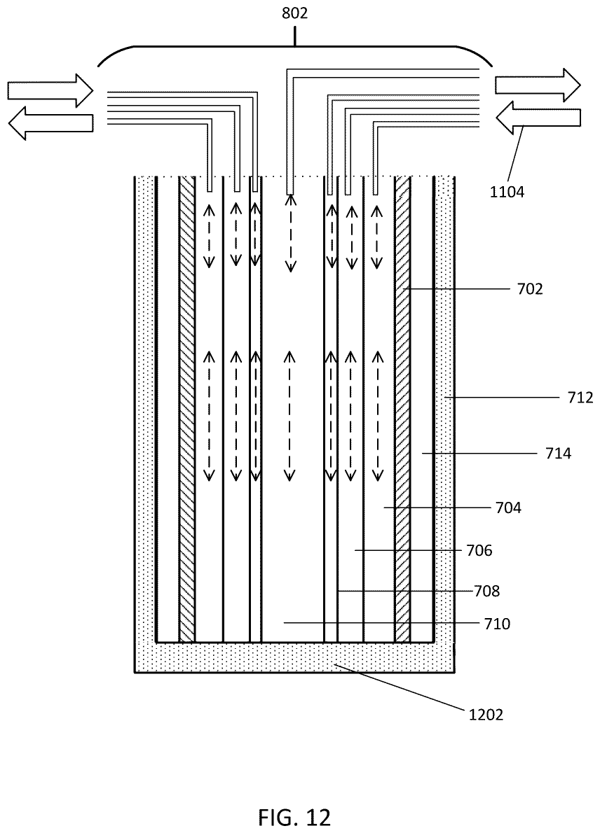

Using the two-stage approach detailed above, noble gas can be introduced into channels of the preform in a different way. FIGS. 11 and 12 show examples where the channels (the hollow core and the plurality of voids) of the preform are sealed independently. FIG. 11 shows an example where the tubular cladding 702 is joined at an end 1102 causing each of the channels to be sealed individually at the same end. FIG. 11 can be considered a modification of the examples of FIG. 8 and FIG. 9. FIG. 12 shows an example where an outer jacket 712 is joined at an end 1202 causing each of the channels to be sealed individually at the same end. FIG. 12 can be considered a modification of the example of FIG. 10. In the example of FIG. 12, the cavity 714 between the outer cladding 702 and the outer jacket 712 is not utilized during the purge process. It follows that air present in the cavity 714 during the draw is allowed to escape as the outer jacket 712 shrinks and encapsulates the tubular cladding 702.

Although it is not illustrated in FIGS. 11 and 12, the channels may be sealed with means other than by joining the tubular cladding 702 or the outer jacket 712. For example, a seal (or multiple seals) can be placed over the whole end of the preform thus causing each of the channels to be individually sealed.

When the channels of the preform are individually sealed, noble gas is unable to flow through the internal structure (i.e., the gas is unable to enter through an inlet defined by one channel/cavity and exit through the outlet defined by another channel/cavity). As a result, in order to purge preforms with individually sealed channels, it is appropriate to employ the two-stage approach whereby the sealed channels are evacuated before being backfilled with the noble gas. This is shown by the muti-directional flow 1104 through the arrangement of gas conduits 802 in both FIGS. 11 and 12. These examples show how the two-stage approach to purging preforms is suitable for purging preforms regardless of the structure of the preform.

Once the preform has been purged in step 606, the method for drawing a hollow core optical fiber can include applying a pre-applied pressure prior to and during the drawing of the fiber. Pressure can be applied to the voids (i.e., the inner channels of the capillaries arranged on the inside of the preform) to counteract the surface tension in the softened glass of the preform during the draw of the fiber. If pressure is not applied to the voids, there is a risk that the voids collapse leading to a destruction of the desired internal structure. Applying pressure in the voids of the preform helps control the internal structure of the hollow core optical fiber as it is drawn. In some examples, differential pressure is applied to the different voids as defined by the different sizes of nested capillaries arranged inside the preform. Due to the different diameters of the nested capillaries, the effect of surface tension may differ between the capillaries meaning different pressure levels are required. To apply the pressurization to the voids in the preform, an arrangement of gas conduits comprising tubing inserted into the ends (i.e., inlets) of the voids in the preform (and in some cases, the hollow core as well) is used where the arrangement of gas conduits is connected to a pressurization system. In addition, pressurizing the plurality of voids in the preform also helps eliminate the diffusion of gas from outside of the preform into the plurality of voids during the draw of the fiber, thus further reducing the likelihood of contamination in the hollow core optical fiber.

To reduce the requirement for additional components in the drawing tower, the arrangement of gas conduits configured to flow noble gas through the voids and the hollow core during purging can also be used to apply the pressurization before and during the drawing of the hollow core optical fiber. Configuring the drawing tower such that the preform can be pressurized immediately after it has been purged further reduces the likelihood any contaminants (including nitrogen and oxygen) can enter the preform voids and hollow core before drawing.

Referring back to FIG. 6, once the purging of the preform is complete and, if implemented, the preform is pressurized, a hollow core optical fiber is fabricated by feeding the purged preform through a drawing furnace in a conventional manner. As a result of the preform being purged, the drawing of the hollow core optical fiber is performed whilst the plurality of voids and hollow core are, at least substantially, kept free of contaminants. For example, whilst the preform is softened in a draw furnace, tension can be applied to the fiber to control the speed at which the fiber is drawn through the draw furnace. The draw furnace is heated to a temperature suitable for softening the preform material. For example, the temperature of the drawing furnace may be at least 1800° C. to ensure the glass is softened sufficiently to draw the hollow core optical fiber. In other example, the temperature of the drawing furnace may be between 1900 to 2200° C. which may depend on the size of the preform and other draw parameters such as draw speed.

Since the preform has been purged prior to being drawn, the likelihood of contaminants being present in the drawn hollow core optical fiber is significantly lower. Performing the purging before the preform is drawn is far more effective than attempting to purge the fiber after drawing due to the microscale diameter of the fiber. In addition, when the length of the hollow core optical fiber extends beyond tens of kilometers, purging the hollow core optical fiber would take an unrealistically long time and be impractical for manufacturing purposes.

The inventors have also identified an additional benefit provided by the purging methods described herein. Purging a preform with an appropriate gas type can help reduce the effects of optical nonlinearities caused by species that otherwise may be present in the hollow core of a hollow core fiber. The main nonlinear effects that can be excited in the gases contained in the hollow core include stimulated rotational/vibrational Raman, Brillouin, and Kerr processes. This consideration is particularly important for high-power, narrow-linewidth signals used in optical methods like optical time/frequency domain reflectometry. These techniques may be deployed to continually monitor the integrity and performance of the fiber link. The presence of species such as nitrogen N₂ and oxygen O₂ can give rise to nonlinear effects that build up over long lengths and have potential to significantly impair the effectiveness of the above techniques, thereby adversely affecting the reliability of the datacom link. The threshold for exciting these nonlinear effects depends on the type of gas species, pressure, density, and the optical properties of the hollow core fiber mode. In general, noble gases have higher thresholds that other gases for most effects, i.e. they demonstrate comparatively low optical nonlinear effects than most other gas molecules. Purging preforms prior to fiber draw, using the techniques described herein, can therefore help engineer the nonlinear behaviour of hollow core fibers to achieve the desired performance by suppressing or reducing nonlinear effects.

The methods disclosed herein operate in an unconventional manner to achieve improved reliability and reduced optical losses in hollow core fibers by introducing a step where the preform is purged prior to hollow core fiber being drawn from the preform. Since the optical losses caused by gas molecules present in the hollow core fiber is comparatively small to the losses caused by the internal structure, the presence of gas molecules in the fiber has not been properly addressed. Up until recently, hollow core optical fibers with properties suitable for data transmission of lengths longer than 10 km have not been achievable, meaning the optical losses caused by contaminants present in the hollow core have not caused substantial issues over short lengths of hollow core fiber. Typically, the minor losses caused by contamination can be tolerated or even accounted for through the design of the transmission systems. However, with longer lengths of hollow core optical fiber now becoming feasible, the losses caused by contaminants present in the hollow core has become a new problem. Therefore, there has been no motivation to address the presence of contaminants in the preform, or any consideration that gases such as oxygen and nitrogen may be reacting to create additional species as a result of the high temperatures in the draw furnace.

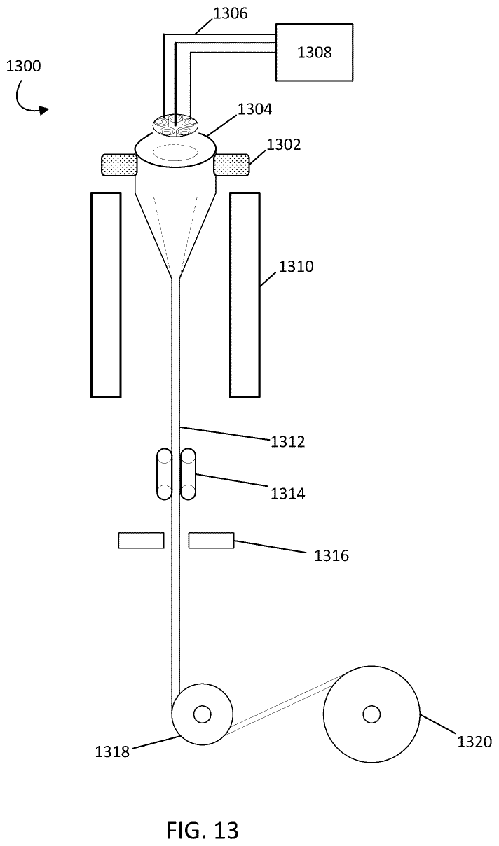

FIG. 13 shows a schematic of a system 1300 for fabricating hollow core optical fibers. The system is suitable for performing the methods described above and it may also be referred to as a draw tower.

The system 1300 includes a preform mount 1302 which holds a preform 1104 in place. In this example, the preform 1304 is shown to be a DNANF, however, the system 1300 is also suitable for other types such as those illustrated in FIGS. 1-5 and any other types of hollow core fibers, either bandgap or antiresonant. An arrangement of gas conduits 1306 is shown which is arranged at the openings of the hollow core and the plurality of voids in the preform 1304 and is connected to a noble gas supply system 1308. The noble gas supply system may be configured to supply argon or any other noble gas (or mixture of noble gases). The arrangement of gas conduits 1306 is configured to supply noble gas to the channels of the preform. In some examples, the arrangement of gas conduits 1306 may also include a channel positioned at the opening of the cavity where the preform 1304 includes an outer jacket. The gas supply system 1308 is configured to provide the supply of noble gas during the purging stage of the hollow core optical fiber drawing process.

The gas supply system 1308 may also be used to pressurize the voids in the preform prior to the preform being drawn into fiber. In this example, the arrangement of gas conduits 1306 may include supply channels to each void in the preform 1304.

The system 1300 also includes a draw furnace 1310 which is heated to a temperature suitable for softening the preform material during the drawing of the hollow core optical fiber 1312. For example, the draw furnace may be heated to at least 1800° C. or in other examples from 1900 to 2200° C. In some examples, the draw furnace is also configured to heat the preform in a two-stage purging process comprising flowing noble gas through the preform at room temperature and then between 200 and 1500° C.

The system 1300 may also include a belt puller 1314 comprising two belts each wrapped around a pair of pulleys. The belt puller 1314 contacts the fiber 1312 as it exits the draw furnace and aids in controlling the speed at which the fiber 1312 is drawn through the drawing furnace. It also helps keep the fiber 1112 in a consistent position during the draw. The system 1300 may also include a fiber diameter monitor 1316 configured to provide live measurements of the diameter of the fiber as it is drawn. The diameter measurements may be fed back to the draw furnace 1310 is adjust the temperature of the furnace to maintain diameters within an acceptable range.

The system 1300 may also include a capstan 1318 which acts to pull the fiber downwards, so it is continually drawn from the softened preform glass. The capstan 1318 and the belt puller 1314 both act to apply tension to the fiber 1312 so that it is pulled from the preform at a consistent rate. The tension applied by the capstan 1318 and the belt puller 1314 may be controlled based on the diameter measurements provided by the diameter monitor 1316. The fiber 1312 may then be taken up off the capstan 1318 onto a spool 1320 to facilitate easy storage.

The system 1300 therefore provides the means to flow noble gas through the preform 1304 prior to the drawing of fiber 1312 from the preform. Additionally, the system 1300 can be configured such that the noble gas supply system 1308 and connected arrangement of gas conduits 1306 is also configured to pressurize the plurality of voids during the drawing of the fiber. The draw furnace 1310 may also be configured to heat the preform 1304 during the purging of the preform 1304. This shows how minimal structural modifications are required to adapt a drawing tower so that the preform can be purged before the fiber is drawn. In addition, a system 1300 which includes the means to purge and pressurize the preform using the same arrangement of gas conduits 1306 also minimizes the chance of gas molecules (other than the noble gas) entering the preform 1304 before the fiber drawing takes place. Finally, a draw tower configured to purge the preform using the draw furnace 1310 to heat the preform during the purge also improves contamination removal as well as removes the required for a separate heating vessel.

Alternatively, or in addition to the other examples described herein, examples include any combination of the following:

Clause A. A method of fabricating a hollow core optical fiber, the method comprising: providing a preform comprising a transverse cross-sectional structure comprising a hollow core surrounded by a plurality of capillaries defining a plurality of voids encased by a tubular cladding, wherein the hollow core and the plurality of voids extend longitudinally along a length of the preform, purging the preform by flowing gas comprising a noble gas through the hollow core and the plurality of voids, and subsequent to purging the preform, drawing a hollow core optical fiber by passing the purged preform through a draw furnace heated to a temperature suitable for softening a material of the preform.

Clause B. The method of clause A, wherein purging the preform comprises flowing a noble gas through the preform to dilute gas already present in the hollow core and the plurality of voids with the noble gas.

Clause C. The method of clause A, wherein purging the preform comprises evacuating the preform followed by flowing gas comprising the noble gas through the hollow core and the plurality of voids.

Clause D. The method of clause C, further comprising following the flowing of the gas comprising the noble gas through the hollow core and the plurality of voids, repeating the evacuation of the preform and the subsequent flowing of the gas comprising the noble gas through the hollow core and the plurality of voids.

Clause E. The method of any of clauses A to D, wherein purging the preform is performed at room temperature for a first time period and subsequently at 200 to 1500° C. for a second time period.

Clause F. The method of any of clauses A to E, wherein the draw furnace is used to provide the temperature of 200 to 1500° C. during the second time period.

Clause G. The method of clause E or clause F, wherein during the first time period, the gas used to purge the preform comprises a mixture of the noble gas and a reactive gas, and during the second time period, the gas used to purge the preform comprises only the noble gas.

Clause H. The method of any of clauses A to G, wherein the preform further comprises an outer jacket defining a cavity between the outer jacket and an outer surface of the tubular cladding, and wherein the purging the preform further comprises flowing the gas comprising the noble gas through the hollow core and the plurality of voids acting as inlets and flowing the gas comprising the noble gas out of the cavity acting as an outlet.

Clause I. The method of any of clauses A to H, further comprising subsequent to purging the preform and prior to drawing the hollow core optical fiber, pressurizing the voids and maintaining the pressurization of the voids during the drawing of the hollow core optical fiber, wherein the pressurization is applied using a pressurization system with gas conduits connected to openings of the hollow core and the voids, and wherein the purging of the preform is performed using the same pressurization system and gas conduits as using to pressurize the voids.

Clause J. The method of any of clauses A to I, wherein the noble gas is argon.

Clause K. The method of any of clauses A to J, further comprising: during the purging of the preform, determining a concentration present of the noble gas that is being flowed through the hollow core and the plurality of voids, and in response to the concentration of the noble gas being above a predetermined threshold, cease the purging of the preform and commence the drawing of the hollow core optical fiber.

Clause L. The method of any of clause A to K, wherein providing the preform comprises drawing the preform with an outer diameter of 0.1 to 10 mm from an initial preform with an outer diameter of at least 20 mm.

Clause M. The method of any of clause A to L, wherein the structure of the preform is an antiresonant hollow core fiber structure comprising a plurality of outer capillaries arranged in a ring around an inner surface of the tubular cladding, wherein the ring of outer capillaries defines the hollow core and a channel of the outer capillary defines a void of the plurality of voids, a plurality of middle capillaries each nested inside one of the plurality of outer capillaries, wherein the channel of the middle capillary defines a void of the plurality of voids, and a plurality of inner capillaries each nested inside one of the plurality of middle capillaries, wherein the channel of the inner capillary defines a void of the plurality of voids.

Clause N. A system for fabricating a hollow core optical fiber, the system comprising a preform mount for holding a preform, a noble gas supply system connected to an arrangement of gas conduits, wherein the arrangement of gas conduits includes channels with openings positioned where the openings of a hollow core and a plurality capillaries defining a plurality of voids of a preform would be positioned with a preform mounted in the preform mount, and wherein the noble gas supply system is configured to flow gas comprising a noble gas through the preform mounted in the preform mount, and a draw furnace which is configured to be heated to a temperature suitable for softening a material of the preform.

Clause O. The system of clause N, wherein the noble gas supply system is further configured to pressurize the plurality of voids of the preform.

Clause P. A method of fabricating a hollow core optical fiber, the method comprising providing a preform comprising a transverse cross-sectional structure comprising a hollow core surrounded by a plurality of capillaries defining a plurality of voids encased by a tubular cladding, wherein the hollow core and the plurality of voids extend longitudinally along a length of the preform, purging the preform by flowing a gas comprising a noble gas through the hollow core and the plurality of voids, wherein purging the preform comprises evacuating the preform followed by flowing the noble gas through the hollow core and the plurality of voids, and subsequent to purging the preform, drawing a hollow core optical fiber by passing the purged preform through a draw furnace heated to a temperature suitable for softening a material of the preform.

Clause Q. The method of clause P, further comprising following the flowing of the gas comprising the noble gas through the hollow core and the plurality of voids, repeating the evacuation of the preform and the subsequent flowing of the gas comprising the noble gas through the hollow core and the plurality of voids.

Clause R. The method of clause P, wherein purging the preform is performed at room temperature for a first time period and subsequently at 200 to 1500° C. for a second time period.

Clause S. The method of clause R, wherein the draw furnace is used to provide the temperature of 200 to 1500° C. during the second time period.

Clause T. The method of clause P, wherein the preform further comprises an outer jacket defining a cavity between the outer jacket and an outer surface of the tubular cladding, and wherein the purging the preform further comprises flowing the gas comprising the noble gas through the hollow core and the plurality of voids acting as inlets and flowing the gas comprising the noble gas out of the cavity acting as an outlet.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A method of fabricating a hollow core optical fiber, the method comprising:
providing a preform comprising a transverse cross-sectional structure comprising a hollow core surrounded by a plurality of capillaries defining a plurality of voids encased by a tubular cladding, wherein the hollow core and the plurality of voids extend longitudinally along a length of the preform;
purging the preform by flowing gas comprising a noble gas through the hollow core and the plurality of voids; and
subsequent to purging the preform, drawing a hollow core optical fiber by passing the purged preform through a draw furnace heated to a temperature suitable for softening a material of the preform.

2. The method of claim 1, wherein purging the preform comprises flowing a noble gas through the preform to dilute gas already present in the hollow core and the plurality of voids with the gas comprising the noble gas.

3. The method of claim 1, wherein purging the preform comprises evacuating the preform followed by flowing gas comprising the noble gas through the hollow core and the plurality of voids.

4. The method of claim 3 further comprising, following the flowing of the gas comprising the noble gas through the hollow core and the plurality of voids, repeating the evacuation of the preform and the subsequent flowing of the gas comprising the noble gas through the hollow core and the plurality of voids.

5. The method of claim 1, wherein purging the preform is performed at room temperature for a first time period and subsequently at 200 to 1500° C. for a second time period.

6. The method of claim 5, wherein the draw furnace is used to provide the temperature of 500 to 1500° C. during the second time period.

7. The method of claim 5, wherein during the first time period, the gas used to purge the preform comprises a mixture of the noble gas and a reactive gas, and during the second time period, the gas used to purge the preform comprises only the noble gas.

8. The method of claim 1, wherein the preform further comprises an outer jacket defining a cavity between the outer jacket and an outer surface of the tubular cladding; and
wherein the purging the preform further comprises flowing the gas comprising the noble gas through the hollow core and the plurality of voids acting as inlets and flowing the gas comprising the noble gas out of the cavity acting as an outlet.

9. The method of claim 1, further comprising:
subsequent to purging the preform and prior to drawing the hollow core optical fiber, pressurizing the voids and maintaining the pressurization of the voids during the drawing of the hollow core optical fiber, wherein the pressurization is applied using a pressurization system with gas conduits connected to openings of the hollow core and the voids, and wherein the purging of the preform is performed using the same pressurization system and gas conduits as using to pressurize the voids.

10. The method of claim 1, further comprising:
during the purging of the preform, determining a concentration present of the noble gas that is being flowed through the hollow core and the plurality of voids; and
in response to the concentration of the noble gas being above a predetermined threshold, cease the purging of the preform and commence the drawing of the hollow core optical fiber.

11. The method of claim 1, wherein providing the preform comprises drawing the preform with an outer diameter of 0.1 to 10 mm from an initial preform with an outer diameter of at least 20 mm.

12. The method of claim 1, wherein the structure of the preform is an antiresonant hollow core fiber structure comprising:
a plurality of outer capillaries arranged in a ring around an inner surface of the tubular cladding, wherein the ring of outer capillaries defines the hollow core and a channel of the outer capillary defines a void of the plurality of voids;
a plurality of middle capillaries each nested inside one of the plurality of outer capillaries, wherein the channel of the middle capillary defines a void of the plurality of voids; and
a plurality of inner capillaries each nested inside one of the plurality of middle capillaries, wherein the channel of the inner capillary defines a void of the plurality of voids.

13. A system for fabricating a hollow core optical fiber, the system comprising:
a preform mount for holding a preform;
a noble gas supply system connected to an arrangement of gas conduits, wherein the arrangement of gas conduits includes channels with openings positioned where the openings of a hollow core and a plurality capillaries defining a plurality of voids of a preform would be positioned with a preform mounted in the preform mount, and wherein the noble gas supply system is configured to flow gas comprising a noble gas through the preform mounted in the preform mount; and
a draw furnace which is configured to be heated to a temperature suitable for softening a material of the preform.

14. The system of claim 13, wherein the noble gas supply system is further configured to pressurize the plurality of voids of the preform.

15. The system of claim 13, wherein the noble gas supply system is configured to flow noble gas through the preform at room temperature for a first time period and subsequently at 200 to 1500° C. for a second time period, and wherein the draw furnace is further configured to provide the temperature of 500 to 1500° C. during the second time period.

16. A method of fabricating a hollow core optical fiber, the method comprising:
providing a preform comprising a transverse cross-sectional structure comprising a hollow core surrounded by a plurality of capillaries defining a plurality of voids encased by a tubular cladding, wherein the hollow core and the plurality of voids extend longitudinally along a length of the preform;
purging the preform by flowing a gas comprising a noble gas through the hollow core and the plurality of voids, wherein purging the preform comprises evacuating the preform followed by flowing the noble gas through the hollow core and the plurality of voids; and
subsequent to purging the preform, drawing a hollow core optical fiber by passing the purged preform through a draw furnace heated to a temperature suitable for softening a material of the preform.

17. The method of claim 16 further comprising, following the flowing of the gas comprising the noble gas through the hollow core and the plurality of voids, repeating the evacuation of the preform and the subsequent flowing of the gas comprising the noble gas through the hollow core and the plurality of voids.

18. The method of claim 16, wherein purging the preform is performed at room temperature for a first time period and subsequently at 200 to 1500° C. for a second time period.

19. The method of claim 18, wherein the draw furnace is used to provide the temperature of 200 to 1500° C. during the second time period.

20. The method of claim 16, wherein the preform further comprises an outer jacket defining a cavity between the outer jacket and an outer surface of the tubular cladding; and
wherein the purging the preform further comprises flowing the gas comprising the noble gas through the hollow core and the plurality of voids acting as inlets and flowing the gas comprising the noble gas out of the cavity acting as an outlet.
